(19) United States
(12) Patent Application Publication
(10) Pub. No.: US 2011/0162804 A1
(43) Pub. Date: Jul. 7, 2011

(54) MOTORIZED GLUE ROLL

(76) Inventors: Antonio Secchi, Pully (CH); Giuseppe Femia, Pully (CH); Emilio Ribecco, Pully (CH); Giulio Sassi, Pully (CH)

(21) Appl. No.: 12/999,264

(22) PCT Filed: Jun. 24, 2008
(86) PCT No.: PCT/EP08/58026

§ 371 Date: Mar. 25, 2011

(51) Int. Cl. B05C 5/02

(52) U.S. Cl. 156/356; 156/578

(57) ABSTRACT

The present invention relates to an improved glue roll to be used mainly in labelling machines for labelling containers such as bottles, particularly for cold glue labelling groups. In particular, the present invention relates to a gluing group (10) comprising a glue roll (1) and a frame (14) for mounting the said gluing group (10) to a labelling machine, characterised in that the said glue roll (1) comprises motor means (2), having a stator (4) and a rotor (5), and gluing means (3) mounted on said rotor (5).

The present invention relates to an improved glue roll to be used mainly in labelling machines for labelling containers such as bottles, particularly for cold glue labelling groups.

Labelling machines for gluing labels and transferring them onto the surface of containers are known and widespread used. In these machines the containers are carried by a carrousel and come into contact with a labelling unit. In one type of machines, the labelling unit comprises a so called “vacuum drum” that receives a label strip from a roll feeding group, cuts the label at the appropriate length, glues the label by means of appropriate means, such as a glue roll, spray and injector systems or the like, and finally transfers the label to the container. In another type, the labels are pre-cut and are dispensed from a stack.

The present invention addresses specifically those machines that use a glue roll for gluing labels or other items.

In conventional machines, the glue roll is normally driven by the main carrousel motor, through a mechanical transmission (gear system, belts or the like). In some cases, a dedicated brushless motor is used, but again this is operatively connected to the glue roll by drive gears or belts. These systems have a first disadvantage due to their bulky dimensions and the difficulties in mounting or dismounting the group from the machine. Besides this problem, another important disadvantage consists in the bad coupling tolerances between glue roll and label handling device that is again dependent from the mechanical transmission of the movement.

This latter problem is even more sensible in the labelling machines that use pre-cut labels, like the ones typically used for labelling beer bottles. These machines comprise a rotating carrousel, wherein a plurality of arcuated pads are rotatably mounted. The movement of the arcuated pads, which are usually coated with a gummy layer, is such as that, when each pad comes into contact with the glue roll for taking glue, it rotates in the opposite direction in order to contact its whole surface with the glue roll. The overall movement of the arcuated pads combines the circular movement of the carrousel on which they are mounted with their own eccentric rotation, so that it is eccentric. Thus, a bad movement coupling between glue roll and pads results in these latter being dragged. The gummy surface is therefore subjected to a continuous friction bringing to the necessity to replace the pads frequently.

It is therefore an object of the present invention to provide a glue roll system that overcomes the above drawbacks, as defined in the appended claims whose definitions are integral part of the present description.

Further features and advantages of the present invention will be better understood from the description of a preferred embodiment, which is given below by way of a non-limiting illustration, with reference to the following figures:

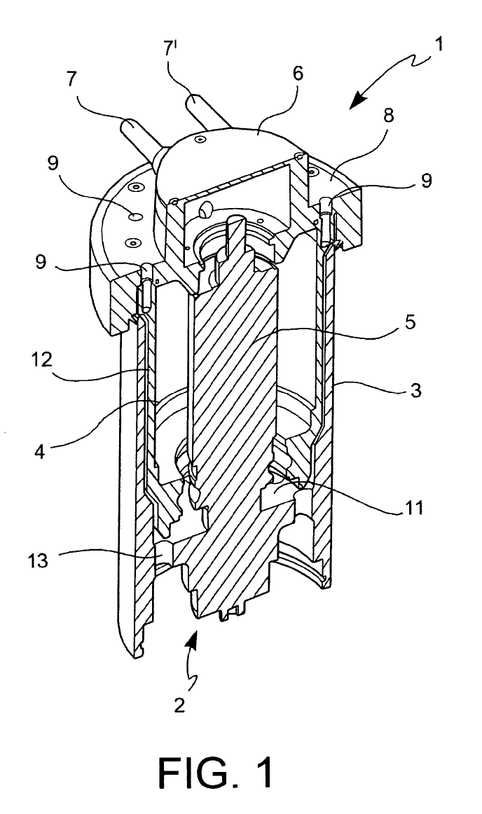

FIG. 1 is a perspective cross section view of the glue roll of the invention;

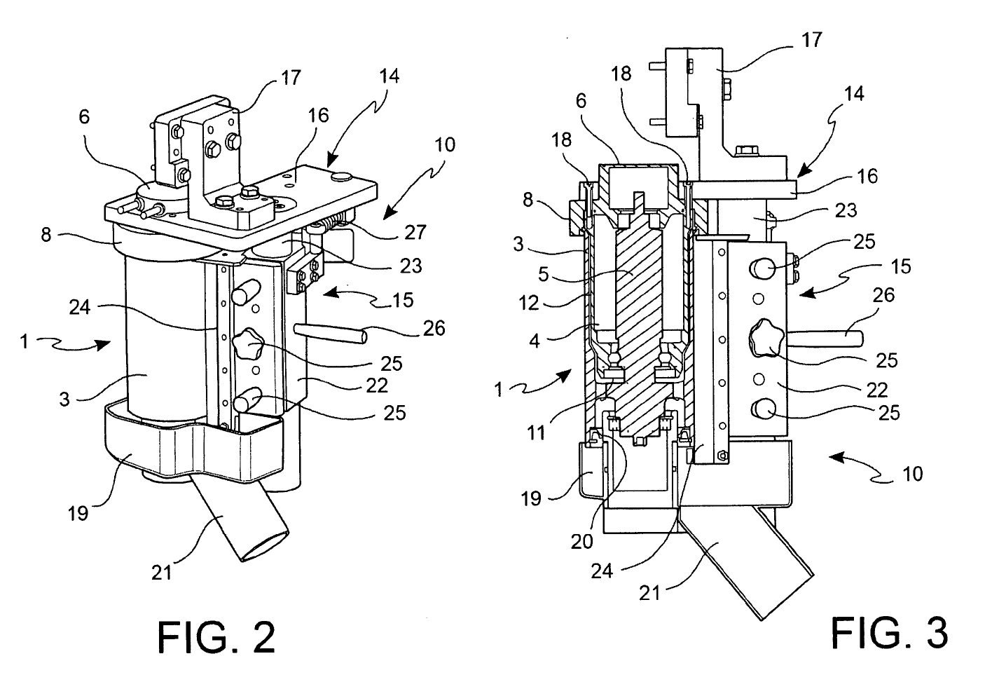

FIG. 2 is a perspective view of a gluing group carrying the glue roll of FIG. 1;

FIG. 3 is a side sectional view of the gluing group of FIG. 2.

With reference to the figures, the motorised glue roll of the invention is indicated with the numeral 1. The motorised glue roll 1 comprises motor means 2, having a stator 4 and a rotor 5, and gluing means 3 mounted on said rotor 5. Preferably, the gluing means 3 are directly mounted on the rotor 5, i.e., they are mounted to the rotor 5 without interposition of transmission means like gears, belts, shafts or the like.

The said motor means 2 preferably are a direct drive (DC) torque motor, more preferably a brushless motor. These motor means 2 have a stator 4, comprising the wound element, positioned coaxially around the rotor 5.

In the inventive motor means 2, the stator 4 has a cylindrical shape and is open at the bottom, while its top is closed and terminates with a turret element 6 hosting power and signal connectors 7, 7′ for the motor. An outwardly faced flange 8 is positioned in the region between the top portion of the stator 4 and the turret element 6. The flange 8 comprises one or more holes 9, for examples threaded holes, for fixing the glue roll 1 to the gluing group 10.

Preferably, stator 4, turret element 6 and flange 8 are integral.

The rotor 5 is of substantially cylindrical shape and comprises linking means 11 that connect the rotor 5 to the gluing means 3. Preferably, the linking means 11 are a flanged element that extends outwardly from the rotor 5, bridges the stator 4 at its bottom end and links the gluing means 3. Preferably, rotor 5, linking means 11 and gluing means 3 are integral.

The gluing means 3 comprises a tubular element with a cylindrical outer surface and an inner surface that is substantially complementary in shape to the outer surface of the stator 4, but has a greater diameter, so that a gap 12 is created between the two surfaces. The gap 12 serves the function to allow the circulation of a cooling fluid, such as cooling air. This is important, as the glue, which is deposited onto the outer surface of the gluing means 3, should not be heated above 30-40° C. Since the motor generates heat, the gap 12 with circulating cooling fluid allows the gluing means 3 to be kept at an appropriate temperature.

The fluid circulation in the gap 12 can be achieved by suction of external air due to the vortex created by rotation of the gluing means 3 with respect to the stator 4. However, suitable fan means can also be provided in order to inflate air or other cooling fluid from the bottom of the glue roll 1.

To this end, the linking means 11 may comprise openings 13 to put into flow communication the gap 12 with the exterior.

The glue roll 1 is mounted on a gluing group 10 which comprises a frame 14 and glue spreading means 15 for spreading glue onto the outer surface of the glue roll 1.

The frame 14 comprises an upper plate 16 that can be fixed to a labelling machine (not shown) through a fixing element 17. The upper plate 16 is provided with a through hole of suitable diameter to couple with the turret element 6 of the glue roll 1 and suitable through holes designed to engage with fixing means 18, such as screws or the like, to fix the glue roll 1 to the upper plate 16 of the frame 14. In particular, the turret element 6 of the glue roll 1 is inserted into the corresponding hole of the upper plate 16 from the bottom upwards, while the fixing means 18 are inserted from the top, pass through the through holes in the upper plate 16 and engage the holes 9 of the flange 8 of the glue roll 1.

On the upper plate 16 can also be mounted delivery means for the glue. These delivery means (not shown) are conventional ones and can be simply constituted by an external cannula that takes the glue from a remote tank and delivers it directly onto the top portion of the outer surface of the gluing means 3.

The frame 14 also comprises a base element 19 onto which the glue roll 1 is mounted. The base element 19 comprises collecting means 20 for the excess glue that drains from the gluing means 3, the said excess glue being removed and possibly recycled through a collecting duct 21.

The frame 14 supports the said glue spreading means 15. These latter comprise an elongated member 22 that extends between the upper plate 16 and the base element 19 of the frame 14, all along the outer surface of the gluing means 3. The elongated member 22 is hinged at the top and at the bottom to the upper plate 16 and the base element 19, respectively, by means of suitable hinging pins (only the upper hinging pin 23 between the elongated member 22 and the top is visible).

The elongated member 22 carries a spreading blade 24, that is removably mounted on it and can be fixed by suitable fixing means 25 that can be operated through suitable knobs.

A handle 26 allows the spreading blade 24 to be taken away from the gluing means 3 surface, by rotating the elongated member 22 around the hinging pins 23, for maintainance operations.

Adjustment means 27, such as a micrometric screw means, are also provided to finely tune the distance of the spreading blade 24 from the gluing means 3 surface, when the spreading blade 24 is in the operating position. In such a way, it is possible to obtain an uniform layer of glue of the wanted thickness on the gluing means 3. These adjustment means 27 act onto the spreading blade 24 by means of suitable leverages or wedges according to conventional means.

On-off means (not shown) are also provided for contacting the spreading blade 24 with the outer surface of the gluing means 3 or alternatively for setting it at a distance from the said surface normally corresponding to the operating position. These on-off means, for example an electronic valve controlled by a PLC, make the elongated member 22 to rotate of a small angle in order to set the blade 24 at the contact position with the gluing means 3 or at the operating position. The blade 24 is made to contact the surface of the gluing means 3 while rotating the glue roll 1 in order to clean such a surface from residual dried glue that can deposit and dry during the maintainance operations of the machine. This cleaning operation is normally performed before reactivating the labeling machine after a rest period.

According to a particular embodiment, the on-off means can be operated by the PLC according to a predefined pulse cleaning cycle, wherein the blade 24 is made to contact the gluing means 3 for a few seconds (2-3 seconds) and then is taken away for again a few seconds and so on. This cleaning cycle allows the motor not to be overloaded.

The functioning of the gluing group 10 of the invention does not substantially differ from the conventional machines and has been already clarified in the above description of the preferred embodiments.

The advantages of the inventive apparatus are clear. No transmission means are provided between the motor means and the glue roll 1, as the motor directly transmits the motion to the roll. In such a way, the effects of bad tolerances are dramatically reduced.

The provision of the aerated gap 12 solves the problem of heating of the surface of the gluing means 3, which would otherwise be detrimental to the gluing operations.

Also the cleaning operations of the glue roll 1 have been optimized thanks to the PLC controlled on-off means for the spreading blade 24, which provides for an efficient cleaning cycle.

It will be appreciated that only particular embodiments of the present invention have been described herein, to which those skilled in the art will be able to make any and all modifications necessary for its adjustment to specific applications, without however departing from the scope of protection of the present invention as defined in the annexed claims.

1. Gluing group (10) comprising a glue roll (1) and a frame (14) for mounting the said gluing group (10) to a labelling machine, characterised in that the said glue roll (1) comprises motor means (2), having a stator (4) and a rotor (5), and gluing means (3) mounted on said rotor (5).

2. Gluing group (10) according to claim 1, wherein the said gluing means (3) are directly mounted on the said rotor (5).

3. Gluing group (10) according to claim 1, wherein the said stator (4) is positioned coaxially around the said rotor (5) and the said gluing means (3) are positioned coaxially around the said stator (4), linking means (11) connecting the said rotor (5) to the said gluing means (3).

4. Gluing group (10) according to claim 3, wherein the said rotor (5), linking means (11) and gluing means (3) are integral.

5. Gluing group (10) according to claim 3, wherein between the inner surface of the said gluing means (3) and the outer surface of the said stator (4) is created a gap (12) for circulating a cooling fluid such as air.

6. Gluing group (10) according to claim 5, wherein the cooling fluid is force-circulated through fan means.

7. Gluing group (10) according to claim 1, wherein the top end of the said stator (4) terminates with a turret element (6) hosting power and signal connectors (7, 7′) for the motor, an outwardly faced flange (8) being positioned in the region between the top portion of the stator (4) and the turret element (6), the flange (8) comprising one or more holes (9) for fixing the glue roll (1) to the gluing group (10).

8. Gluing group (10) according to claim 7, wherein stator (4), turret element (6) and flange (8) are integral.

9. Gluing group (10) according to claim 1, wherein the said frame (14) comprises an upper plate (16) provided with a through hole of suitable diameter to couple with the turret element (6) of the glue roll (1) and suitable through holes designed to engage with fixing means (18) to fix the glue roll (1) to the upper plate (16) of the frame (14).

10. Gluing group (10) according to claim 1, wherein the said frame (14) comprises a base element (19) onto which the glue roll (1) is mounted, the said base element (19) comprising collecting means (20) for the excess glue that drains from the gluing means (3) and a collecting duct (21) for removing and recycling the said excess glue.

11. Gluing group (10) according to claim 1, further comprising glue spreading means (15) for spreading a layer of glue onto the outer surface of the gluing means (3) of said glue roll (1).

12. Gluing group (10) according to claim 11, wherein the said glue spreading means (15) comprise an elongated member (22) that extends between the upper plate (16) and the base element (19) of the frame (14) and that is hinged at the top and at the bottom to the upper plate (16) and the base element (19), respectively.

13. Gluing group (10) according to claim 12, wherein the said elongated member (22) carries a spreading blade (24), which is removably mounted on it.

14. Gluing group (10) according to claim 13, wherein the said elongated member (22) comprises a handle (26) allowing the spreading blade (24) to be taken away from the surface of the gluing means (3), by rotating the elongated member (22) around its hinging axis, for maintainance operations.

15. Gluing group (10) according to claim 13, wherein adjustment means (27) are provided to finely tune the distance of the spreading blade (24) from the surface of the gluing means (3), when the spreading blade (24) is in the operating position.

16. Gluing group (10) according to claim 13, wherein on-off means are provided for contacting the spreading blade (24) with the outer surface of the gluing means (3) or alternatively for setting it at a distance from the said surface normally corresponding to the operating position.

17. Gluing group (10) according to claim 16, wherein the said on-off means are an electronic valve controlled by a PLC, which makes the elongated member (22) to rotate of a small angle in order to set the spreading blade (24) at the contact position with the gluing means (3) or at the operating position.

18. Gluing group (10) according to claim 17, wherein the said on-off means can be operated by the PLC according to a predefined pulse cleaning cycle, wherein the spreading blade (24) is made to contact the gluing means (3) for a few seconds and then is taken away for again a few seconds and so on.

19. Gluing group (10) according to claim 18, wherein the said motor means (2) are a direct drive torque motor, preferably a brushless motor.
